(19) United States
(12) Patent Application Publication
(10) Pub. No.: US 2019/0217396 A1
(43) Pub. Date: Jul. 18, 2019

(54) HOLDER AND MACHINE TOOL

(71) Applicant: OKUMA Corporation, Niwa-gun (JP)

(72) Inventor: Hiroyuki SUGIURA, Niwa-gun (JP)

(21) Appl. No.: 16/249,201

(22) Filed: Jan. 16, 2019

(30) Foreign Application Priority Data
Jan. 18, 2018 (JP) 2018-006777

(51) Int. Cl. B23B 23/00; B23Q 1/28

(52) U.S. Cl. CPC B23B 23/005; B23B 2260/07; B23Q 1/28

(57) ABSTRACT

A holder for clamping a tool includes a clamping mechanism for clamping the tool, and an exposed portion. The clamping mechanism is switchable between a clamping state and an unclamping state. The clamping state is a state in which removal of the tool from the holder is hindered. The unclamping state is a state in which removal of the tool from the holder is allowed. The exposed portion is exposed outside the holder and directly or indirectly and mechanically linked to the clamping mechanism. The exposed portion is pushed in one direction for movement to thereby switch the clamping mechanism to the unclamping state.

### CROSS REFERENCE TO RELATED APPLICATION

The present application claims priority under 35 U.S.C. § 119 to Japanese Patent Application No. 2018-006777 filed on Jan. 18, 2018, which is incorporated herein by reference in its entirety including the specification, claims, drawings, and abstract.

### TECHNICAL FIELD

This specification relates to a holder for holding held members, such as tools or tailstock centers, and to a machine tool that includes the holders.

### BACKGROUND

For further automation and manpower-saving, a technique for automatic exchange of tools and tailstock centers of machine tools is needed. Assume that a tool to be held, or a held member, such as a tool or a tailstock center, is held by a holder and mounted on a turret or a tailstock. The holder is switchable between a clamping state that allows neither mounting or removal of a held member, and an unclamping state that allows mounting or removal of a held member.

Usually, a holder is kept in a clamping state with a screw or a force of a wedge. To exchange held members, a hex key is inserted into a hex hole on the holder and then turned around, whereby the holder is put in an unclamping state to allow mounting or removal of a held member. After the exchange of held members, the hex key is turned around in the counter direction whereby the holder is put in a clamping state.

In other words, conventional holders require complicated motions, such as insertion and turning around of a hex key, to switch between the clamping and unclamping states. Thus, conventional switching between clamping and unclamping states is often made manually.

### CITATION LIST

### Patent Literature

Patent Document 1: JP 2016-144853A
Patent Document 2: JP H05-285766A

Meanwhile, automatic switching between clamping and unclamping states has been suggested. For example, Patent Document 1 discloses a technique for causing a robot to switch between clamping and unclamping states and to mount or remove tools. This technique enables automatic exchange of tools. Unfortunately, the technique disclosed in Patent Document 1 requires a large-scale complicated robot, which causes problems, such as complicated control, large machine tools, and increased costs.

Patent Document 2 discloses a technique for switching a holder between clamping and unclamping states, using a driving force from a motor for rotating tools, built in a turret. That is, a typical turret has a motor for rotating a tool mounted. Patent Document 2 uses the motor not to rotate a tool but to switch a holder between clamping and unclamping states. This technique requires no such large-scale complicated machine as an existing robot. Unfortunately, the technique disclosed in Patent Document 2 cannot rotate a tool, since the motor for rotating a tool is used to switch between the clamping and unclamping states. In other words, the technique disclosed in Patent Document 2 partially deteriorates the function of a machine tool.

In view of the above, this specification discloses a holder and a machine tool including the holder, the holder and the machine tool having simple structures and capable of automatic switching between the respective states of clamping and unclamping held members without deterioration in function of the machine tools.

### SUMMARY

A holder disclosed in this specification is a holder for holding a held member that is a tool or a tailstock center, the holder including a clamping mechanism for clamping the held member, the clamping mechanism being switchable between a clamping state and an unclamping state, the clamping state being a state in which the held member is hindered from being removed from the holder, the unclamping state being a state in which the held member is allowed to be removed from the holder; and an exposed portion exposed outside the holder and directly or indirectly and mechanically linked to the clamping mechanism, the exposed portion for being pushed in one direction for movement to thereby switch the clamping mechanism to the unclamping state.

Since it is possible to switch to the unclamping state by only pushing the exposed portion outside the holder in one direction, provision of a moving body having a complicated shape and capable of complicated motion is unnecessary. Further, since a driving force for rotating a tool from a motor built in the turret is not required to switch to the unclamping state, the holder disclosed in this specification allows use of a rotating tool even while switching. As a result, automatic switching between the respective states of clamping and unclamping a held member is achieved with a simple structure without deterioration in function of the machine tool.

In one embodiment, the clamping mechanism may include a clamping claw being movable between an engaged position and a released position, the engaged position being a position where the clamping claw is engaged with the held member, the released position being a position where engagement of the clamping claw is released, a draw bar being movable between a clamping position and an unclamping position, the clamping position being a position where the clamping claw is hindered from being displaced from the engaged position, the unclamping position being a position where the clamping claw is allowed to be displaced from the engaged position to the released position; and an urging member for urging the draw bar toward the clamping position.

The above-described structure enables clamping of a tool in accordance with the standard, and thus can improve the general utility of holders.

In one embodiment, one end of the draw bar may be exposed outside the holder, a part of the draw bar may function as the exposed portion, the part being exposed outside, the urging member may urge the draw bar in a direction in which the exposed portion moves further outside the holder, and the exposed portion may be pushed toward inside the holder against an urging force of the urging member, whereby the held member is unclamped.

The use of a part of the draw bar as the exposed portion enables reduction in the number of necessary parts, and further simplification of the structure.

In one embodiment, the exposed portion may be linked to the draw bar via a transmission mechanism, and the transmission mechanism may convert a movement motion attributed to the exposed portion being pushed, into a movement motion from the clamping position to the unclamping position to transmit the converted movement motion to the draw bar.

The above-described structure enables ready change in the position where the exposed portion is disposed and the direction in which the exposed portion is to be pushed. The structure also enables boosting of the pushing force to transmit the boosted force to the draw bar.

In one embodiment, the holder may be to be mounted on a turret of a machine tool, the holder may further include a tool-rotating shaft disposed coaxial to the draw bar, for engagement with the held member in a circumferential direction in the clamping state, and a transmission mechanism including one or more pairs of gears, for transmitting rotation of a main rotation shaft of the turret to the tool-rotating shaft, and the rotation of the main rotation shaft may be transmitted to the held member via the transmission mechanism and the tool-rotating shaft.

The above-described structure can transmit the rotation of the rotating shaft of the turret to the held member (a rotating tool) held by the holder so that milling processing can be executed.

A machine tool disclosed in this specification includes the above-described holder; and a moving body for pushing the exposed portion in the one direction for movement.

The above-described structure can automatically, rather than manually, put the holder in an unlocked state.

In one embodiment, the holder may be mounted on a turret mounted on a tool post, and the moving body may be any of a tailstock, a counter spindle, another tool post, and another turret mounted on the other tool post.

The use of a moving body, such as a tailstock, a counter spindle, another tool post, or another turret mounted on the other tool post, mounted in an existing machine tool eliminates the need for a dedicated moving body for switching to an unlocked state. This can simplify the structure of a machine tool and reduce costs.

In one embodiment, the holder may be mounted on a tailstock, and the moving body may be any of a counter spindle, a turret, and a tool post.

The use of a moving body, such as a counter spindle, a turret, or a tool post, mounted in an existing machine tool eliminates the need for a dedicated moving body for switching to an unlocked state. This can simplify the structure of a machine tool and reduce costs.

Another machine tool disclosed in this specification includes the above-described holder; and a moving body on which the holder is to be mounted, wherein the moving body is moved to thereby press the exposed portion onto a structure other than the moving body whereby the held member is unclamped.

The above-described structure does not require a separate moving body for pushing the exposed portion. This can further simplify the structure of a machine tool.

In one embodiment, the above-described machine tool may further include an exchange mechanism for removing or inserting a held member with respect to the holder in the unclamping state.

The provision of the exchange mechanism enables automatic exchange of tools.

The holder and the machine tool disclosed in this specification enable automatic switching between the respective states of clamping and unclamping a held member, with a simple structure and without deterioration in function of the machine tool.

### BRIEF DESCRIPTION OF DRAWINGS

Embodiment(s) of the present disclosure will be described by reference to the following figures, wherein:

FIG. 1 is a perspective view of a machine tool;

FIG. 2 is a cross sectional view of an area around a holder;

FIG. 3 is an enlarged cross sectional view of a major part of a holder;

FIG. 4 is an enlarged view of the part A in FIG. 3 in a clamping state; and

FIG. 5 is an enlarged view of the part A in an unclamping state.

### DESCRIPTION OF EMBODIMENTS

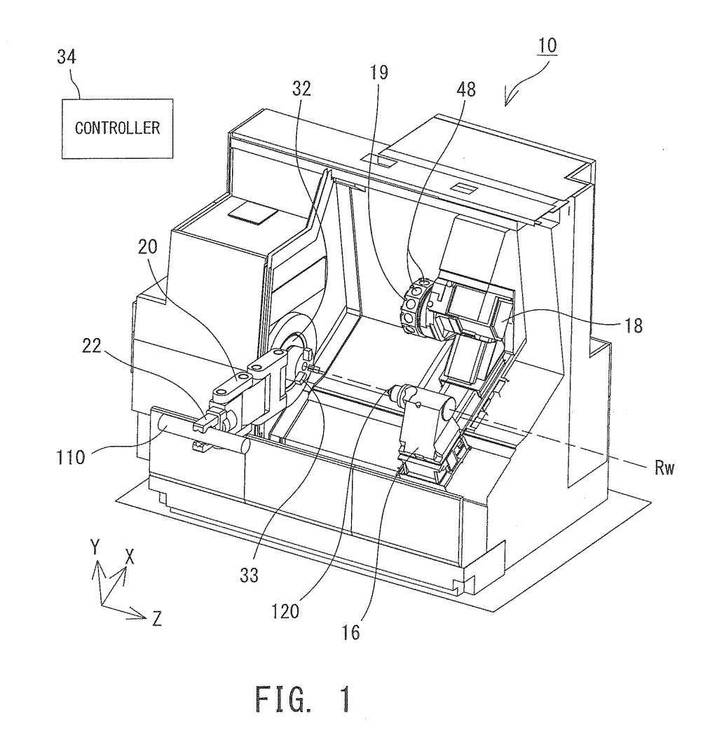

The structure of a machine tool 10 will now be described by reference to the drawings. FIG. 1 illustrates the structure of a machine tool 10. In the description below, a direction parallel to the rotation axis Rw of a workpiece main spindle 32 is defined as the Z axis, a direction parallel to a movement direction orthogonal to the Z axis of a tool post 18 as the X axis, and a direction orthogonal to the X and Z axes as the Y axis. The direction of the Z axis approaching from the workpiece main spindle 32 toward a tailstock 16, the direction of the X axis approaching from the workpiece main spindle 32 toward the tool post 18, and the direction of the Y axis directed upward from the workpiece main spindle 32 are defined as positive directions.

The machine tool 10 machines a workpiece 110 held on the workpiece main spindle 32 with a tool 100 held by the tool post 18. More specifically, the machine tool 10 is a turning center under NC control and having a turret 19 for holding a plurality of tools 100. The machine tool 10 has a machining chamber covered therearound. The machining chamber also has a large opening on its front side. The opening is to be opened and closed by a door (not illustrated in FIG. 1). An operator accesses the respective units inside the machining chamber through the opening. The door provided to the opening is kept closed during machining for maintaining security and a suitable environment.

The machine tool 10 includes a workpiece main spindle unit for holding one end of the workpiece 110 so as to allow revolution, the tool post 18 for holding the tool 100, and the tailstock 16 for supporting the other end of the workpiece 110. The workpiece main spindle unit includes a head stock that incorporates a driving motor (not seen as being hidden by other members), for example, and the workpiece main spindle 32 mounted on the head stock. The workpiece main spindle 32 includes a chuck 33 or a collet for removably holding the workpiece 110 to allow desirable exchange of workpieces 110 to be held. The workpiece main spindle 32 and the chuck 33 revolve around the workpiece rotation axis Rw that extends in the horizontal direction (the Z axial direction in FIG. 1).

The tailstock 16 is disposed so as to be opposed to the workpiece main spindle 32 in the Z axial direction, and supports one end of the workpiece 110 held on the workpiece main spindle 32. The tailstock 16 is positioned such that its central axis coincides with the workpiece rotation axis Rw. The tailstock 16 has a tailstock center 120 having a projecting tip end in a cone shape. During machining, the tip end of the tailstock center 120 is kept abutting on the center of the workpiece 110. The tailstock 16 is movable in the Z axial direction so as to approach or depart with respect to the workpiece 110.

The tool post 18 holds the tool 100. The tool 100 to be held may be a turning tool (for example, cutting tools, or bites) or a milling tool (rotating tools, for example, end mills). The tool post 18 is movable in a direction parallel to the Z axis; that is, a direction parallel to the axis of the workpiece 110. The tool post 18 is disposed on a guide rail that extends in the diameter direction of the workpiece 110, or a direction parallel to the X axis, so as to be movable also in a direction parallel to the X axis. As is obvious from FIG. 1, the X axis is inclined upward relative to the horizontal direction as going farther from a viewer viewing the drawing, when viewed through the opening of the machining chamber.

The tool post 18 has the turret 19 on its end portion. The turret 19 can hold a plurality of tools 100. The turret 19 is substantially cylindrical and rotatable around an axis parallel to the Z axis. The turret 19 has a plurality of spigot holes 48 on its circumferential surface. Each of the spigot holes 48 is used for mounting a holder 50 to be described later. Specifically, the holder 50 is partially inserted into the spigot hole 48 and attached to the turret 19 with a bolt. The holder 50 removably holds the tool 100. Switching between the respective states of clamping and unclamping the tool 100 by the holder 50 is automatically made in the machine tool 10, as will be described later.

At any rate, a plurality of tools 100 are held on the turret 19 via the holders 50. Rotation of the turret 19 enables desirable exchange of tools 100 for use in machining workpieces 110. Moving the tool post 18 in a direction parallel to the Z axis causes the tool 100 held on the turret 19 to move in a direction parallel to the Z axis. Moving the tool post 18 in a direction parallel to the X axis causes the tool 100 held on the turret 19 to move in a direction parallel to the X axis. Moving the tool post 18 in a direction parallel to the X axis enables a change in the extent of cutting into the workpiece 110 by the tool 100.

Inside the machining chamber, a built-in robot 20 is disposed. The built-in robot 20 functions as an exchange mechanism for removing or inserting a tool 100 with respect to the holder 50 in an unclamping state. The built-in robot 20 may have any structure and may be mounted at any position without limitation, that allow insertion and removal (exchange) of the tools 100. Accordingly, as illustrated in FIG. 1, for example, the built-in robot 20 may be a multiple-joint arm robot having an end effecter of a hand mechanism 22 attached on its tip end. Alternatively, the built-in robot 20 may be a robot having a gantry rail or a parallel link, for example. Still alternatively, a tool transport exchanger including a linear motion mechanism or the like, that enables exchange of the tools 100 may be provided in the place of the built-in robot 20.

A controller 34 controls driving of the respective units of the machine tool 10 according to an instruction from an operator. The controller 34 includes, for example, a CPU for various operations, and a memory for storing various control programs and control parameters. The controller 34 has a communication function and can receive various data, such as NC program data, from other devices. The controller 34 may include a numerical controller for calculation of the position of the tool 100 or the workpiece 110, for example, at any time. The controller 34 may include a single device or a plurality of operation devices combined.

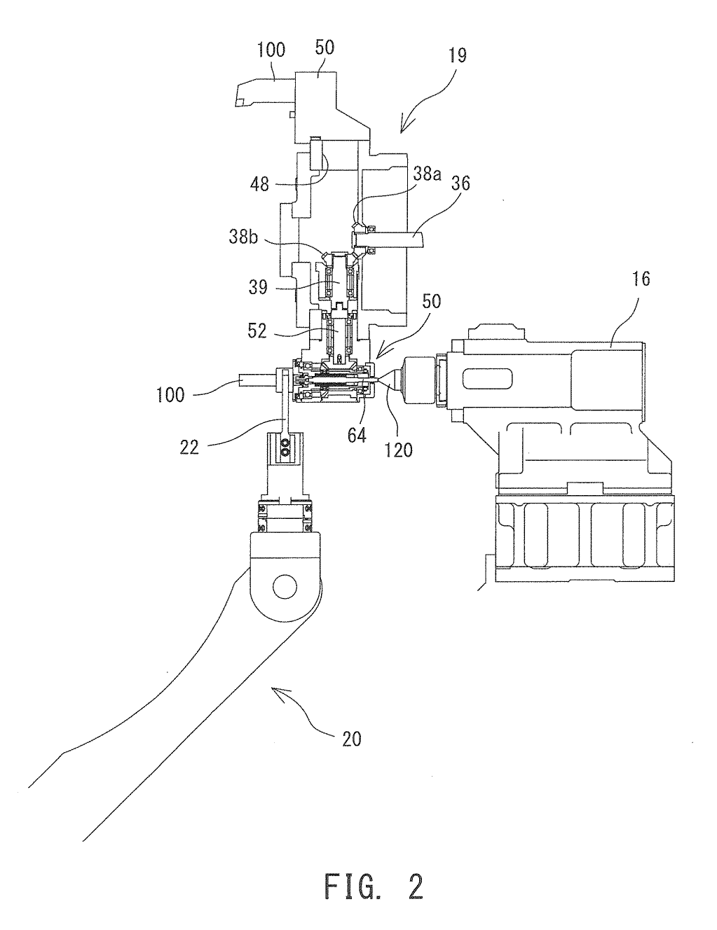

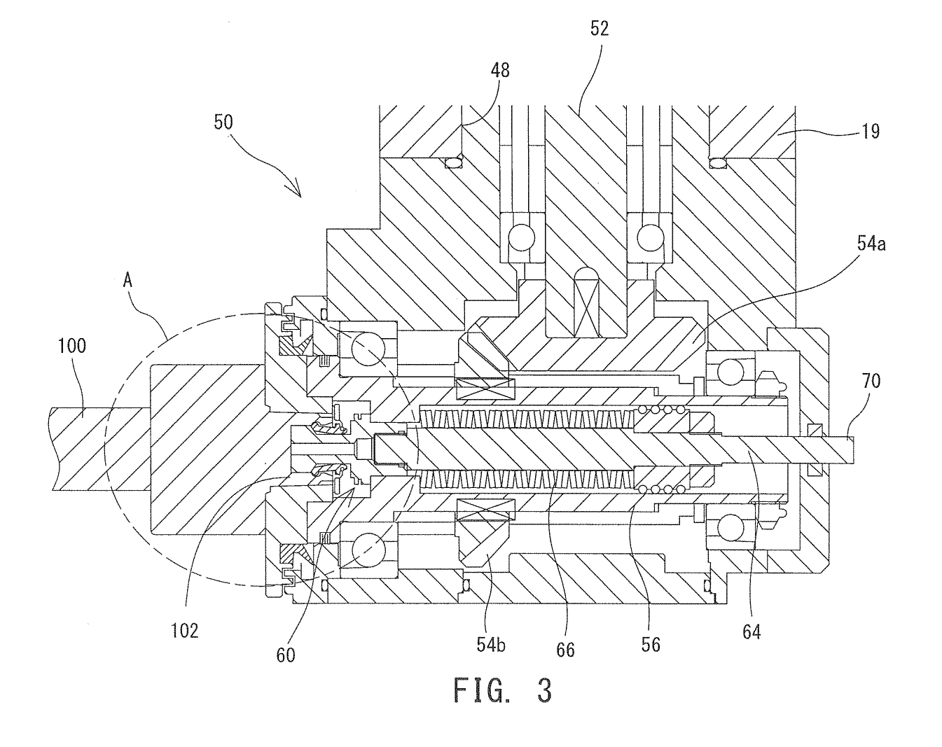

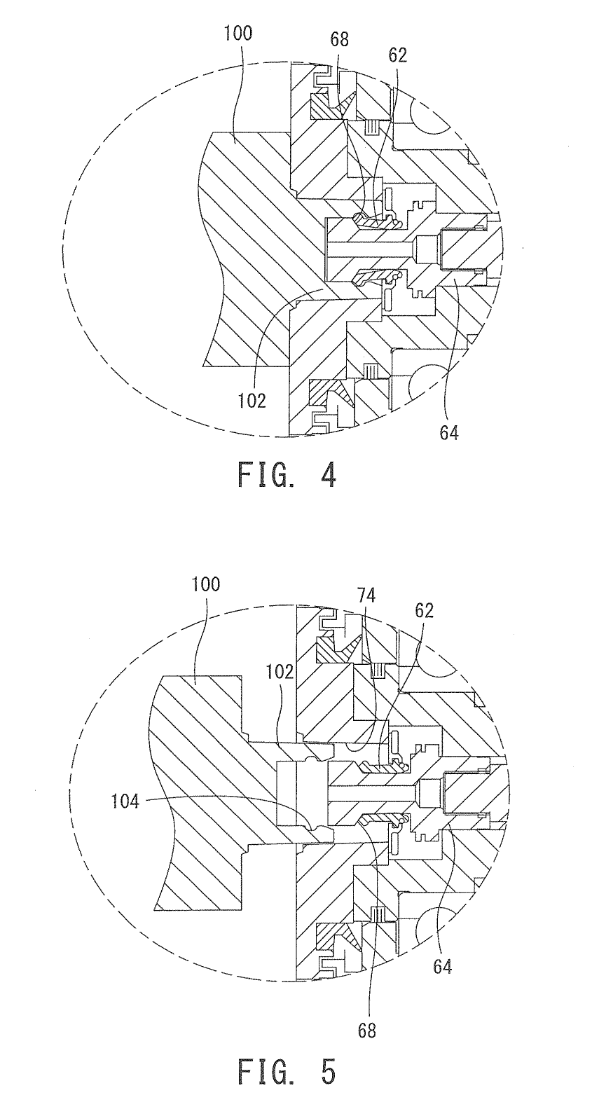

The structure of the holder 50 to be mounted on the turret 19 will now be described. FIG. 2 is a cross sectional view of an area around the holder 50. FIG. 3 is an enlarged cross sectional view of a major part of the holder 50. FIGS. 4 and 5 are enlarged views of the part A in FIG. 3. In particular, FIG. 4 relates to a clamping state; FIG. 5 an unclamping state.

The holder 50 is mounted on the circumferential surface of the turret 19, as described above. The turret 19 can turn around a predetermined turning axis (parallel to the Z axis) with a force from a turn motor (not illustrated). The turret 19 has a main rotation shaft 36 that extends in a direction parallel to the Z axis. The main rotation shaft 36 is a shaft that rotates as being driven by a tool rotating motor (not illustrated). The rotation of the main rotation shaft 36 is subjected to angular conversion by 90 degrees by a pair of bevel gears 38a, 38b before being transmitted to a primary following rotation shaft 39. The primary following rotation shaft 39 is linked via a key or the like to a secondary following rotation shaft 52 mounted on the holder 50.

The rotation of the secondary following rotation shaft 52 is subjected to angular conversion by 90 degrees by a pair of bevel gears 54a, 54b before being transmitted to a tool-rotating shaft 56. The tool-rotating shaft 56 is engaged with the tool 100 in its circumferential direction and rotates to thereby cause the tool 100 to rotate. That is, the rotation of the main rotation shaft 36 on the turret 19 is transmitted to the tool 100 via the bevel gears 38a, 38b, the primary and secondary following rotation shafts 39, 52, the bevel gears 54a, 54b, and the tool rotating shaft 56.

The tool-rotating shaft 56 is a hollow cylinder and incorporates a clamping mechanism 60 for holding the tool 100. The clamping mechanism 60 includes a clamp claw 62, a draw bar 64 for moving the clamp claw 62, and an urging member 66 for urging the draw bar 64. The clamp claw 62 is engaged with a part of a tapered shank 102 of the tool 100. More concretely, a tapered shank 102 is formed on the root of the tool 100. The tapered shank 102 has a shape that becomes thinner in diameter while approaching toward the root (see FIGS. 4 and 5). The tapered shank 102 is a hollow cylinder. The tapered shank 102 has an engagement groove 104 defined on its inner circumferential surface, for engagement with the clamp claw 62.

A tool insertion hole 74 shaped in accordance with the tapered shank 102 is formed on the tip end surface of the holder 50. At a position inside the holder 50, the position corresponding to the engagement groove 104, the clamp claw 62 is provided. The clamp claw 62 swings with a swing axis near the root of the clamp claw 62 at the center to thereby move between an engaged position and a released position. As illustrated in FIG. 4, the engaged position is a position where the tip end of the clamp claw 62 can be engaged with the engagement groove 104. The clamp claw 62 in the engaged position establishes a clamping state that prohibits insertion and removal of the tool 100 with respect to the holder 50. When the tool 100 is inserted into the holder 50 and the clamping state is established, the tool 100 is securely held by the holder 50.

As illustrated in FIG. 5, the released position is a position where the tip end of the clamp claw 62 can be released from engagement with the engagement groove 104. In this example, the released position is defined at a position further inward in the radial direction of the tapered shank 102 than the engaged position. The clamp claw 62 in the released position establishes an unclamping state that allows insertion and removal of the tool 100 with respect to the holder 50. To exchange the tool 100 held in the holder 50, the clamping mechanism 60 is put in the unclamping position.

The draw bar 64 is a bar member that moves in the axial direction and has a tapered surface 68 formed near its tip end. The tapered surface 68 becomes larger in diameter while approaching the tip end of the draw bar 64 (see FIGS. 4 and 5). The tapered surface 68 abuts on the tip end of the clamp claw 62. When the draw bar 64 moves in a direction approaching toward the tool 100, the tip end of the clamp claw 62 can move inward in the radial direction (the released position), as illustrated in FIG. 5. Meanwhile, when the draw bar 64 moves in a direction departing from the tool 100, the tip end of the clamp claw 62 moves outward in the radial direction (the engaged position) to be engaged with the engagement groove 104, or in the clamping state, as illustrated in FIG. 4. The retreated position of the draw bar 64, where the clamp claw 62 is hindered from being displaced from the engaged position, will hereinafter be referred to as a clamping position, while the advanced position of the draw bar 64, where the clamp claw 62 is allowed to be displaced from the engaged position to the released position, will be referred to as an unclamping position.

The urging member 66 urges the draw bar 64 toward the clamp (a direction departing from the tool 100). The urging member 66 may be any member that can urge the draw bar 64 toward the clamp without limitation. In this example, the urging member 66 is a conical spring. The urging member 66 maintains the clamp claw 62 in the clamping state.

The proximal end of the draw bar 64 functions as an exposed portion 70 that is exposed outside the holder 50. The exposed portion 70 can be rephrased as a portion directly and mechanically linked to the clamping mechanism 60. The exposed portion 70 is pushed in the axial direction (pushed into the inside of the holder 50; that is, in a direction approaching the tool 100); in other words, in one direction, against the urging force of the urging member 66, whereby the clamping mechanism 60 is switched to the unclamping state. The clamping mechanism 60 in the unclamping state allows insertion and removal of the tool 100, so that the tools can be exchanged. In summary, to exchange the tools 100, the exposed portion 70 is pushed in one direction.

The exposed portion 70 may be pushed by any moving body provided to the machine tool 10. Since the direction in which the exposed portion 70 is to be pushed is one direction, any object that can move in at least one direction can constitute the moving body. That is, a complicated motion is unnecessary for the moving body. If the exposed portion 70 is a projection to the outside of the holder 50, as illustrated in FIG. 3, the moving body is less likely to interfere with portions other than the exposed portion 70. This eliminates the need for the moving body to have a special shape for avoidance of interference with portions other than the exposed portion 70. In other words, it is unnecessary to provide a dedicated moving body having a special shape for special motion as a moving body for pushing the exposed portion 70. Instead, any moving body conventionally provided to the machine tool 10 can be used without a problem.

Such a moving body can be the tailstock 16, for example. In exchanging tools, the tailstock 16 can be moved toward the holder 50 to thereby push the exposed portion 70 in one direction. Some machine tools 10 may have a counter spindle, another turret, or another tool post. A counter spindle refers to another workpiece main spindle disposed opposed to the workpiece main spindle 32 and movable in the Z axial direction. In the case where a counter spindle is provided, the counter spindle can be used therewith to push the exposed portion 70. Further, some machine tools 10 may have a plurality of turret tool posts. In this case, another turret 19 can be used therewith to push the exposed portion 70 of the holder 50 mounted on one turret 19. Still further, some machine tools 10 may have a tool post with an M main spindle besides a turret tool post. In this case, the tool post with an M main spindle may be used to push the exposed portion 70 of the holder 50 mounted on the turret tool post. In any case, the moving body is only required to move straight and does not necessarily move in a complicated manner or does not necessarily have a complicated shape.

Alternatively, instead of pushing the exposed portion 70 with a moving body, the tool post 18 may be moved to thereby press the exposed portion 70 onto any other structure. A structure to be pressed may include, for example, a wall surface of the machining chamber or a part of a moving body, such as the tailstock 16. As the exposed portion 70 is pushed in one direction in this case as well, the clamping mechanism 60 can be put in the unclamping state.

At any case, pushing the exposed portion 70 for movement in one direction enables switching of the clamping mechanism 60 to the unclamping state in this example. In other words, a driving force for rotating a tool (a driving force of a tool-rotating motor) from a motor in the turret 19 is not necessary in switching to the unclamping state. Resultantly, the holder 50 in this example enables automatic switching to the unclamping state even while using the rotating tool. In other words, the holder 50 in this example enables automatic switching of the clamping mechanism 60 to the unclamping state without deterioration in function of the machine tool 10, or the function of rotating a tool on the turret 19. Once the clamping mechanism 60 is put in the unclamping state, the built-in robot 20 can exchange the tools 100.

More concretely, the procedure of exchanging tools 100 will be described. To exchange the tools 100 on the turret 19, initially, the controller 34 drives the built-in robot 20 to cause the hand mechanism 22 to hold the tool 100 inserted in the holder 50. Subsequently, the controller 34 drives the moving body to therewith push the exposed portion 70 or drives the tool post 18 to therewith press the exposed portion 70 onto another structure. As a result, the draw bar 64 advances to the unclamping position against the urging force of the urging member 66. With this advancement, the clamp claw 62 moves to the released position, or inward in the radial direction. This establishes the unclamping state in which the clamping claw 62 is disengaged with the engagement groove 104. Then, the controller 34 drives the built-in robot 20 to pull out the tool 100 held by the built-in robot 20 from the holder 50 for removal.

The built-in robot 20 places the removed tool 100 in a tool magazine (not illustrated) for storage. The tool magazine may be provided outside the matching chamber, for example, and a plurality of tools may be stored in the tool magazine. In response to an instruction from a user, the controller 34 causes the hand mechanism 22 of the built-in robot 20 to hold a designated tool 100. The controller 34 then drives the built-in robot 20 so as to bring the tool 100 to the holder 50 and insert into the tool insertion hole 74. With the tool 100 inserted in the holder 50, the controller 34 drives the moving body or the tool post 18 to release the exposed portion 70 kept pushed. As a result, the draw bar 64 retreats to the clamping position with the urging force of the urging member 66. Additionally, the clamp claw 62 is brought into engagement with the clamp claw 62 of the tool 100, whereby the tool 100 is securely clamped. Finally, the hand mechanism 22 releases the tool 100 and moves away from the tool 100. This completes automatic exchange of tools.

As is obvious from the above description, the holder 50 has an exposed portion 70 exposed outside to be pushed for movement in one direction for switching to the unclamping state in this example. The provision of the exposed portion 70 eliminates the need for a moving body having a complicated structure (a moving body that moves in a complicated manner or has a complicated shape) for switching to the unclamping state. Moreover, different from Patent Document 2, in this example a driving force for rotating the tool 100 is not used to switch to the unclamping state. As a result, automatic switching of the clamping mechanism 60 between the clamping and unclamping states is achieved with a simple structure and without deterioration in function of the machine tool 10.

Note that the above-described structure is a mere example, and structures other than the provision of the exposed portion 70 to the holder 50 can be desirably changed, the exposed portion 70 being exposed outside the holder 50 and to be pushed for movement in one direction for switching to the unclamping state.

For example, although the holder 50 to be mounted on the turret 19 is described above, the technique disclosed in this specification may be applied to other types of holders 50 for holding a tool 100 or a tailstock center 120. For example, the technique disclosed in this specification can be applied to a holder 50 to be mounted on a flat tool post having linearly aligned mounting portions for holders 50. Alternatively, the technique disclosed in this specification may be applied to a holder 50 for holding the tailstock center 120 rather than the tool 100. That is, the technique disclosed in this specification can be applied to automatic exchange of tailstock centers 120.

Note that the structure of the above-described clamping mechanism 60 is a mere example, and that the clamping mechanism 60 may have other types of structures as long as the clamping mechanism 60 is switchable to the unclamping state upon mechanical transmission of motion from the exposed portion 70. For example, although the clamp claw 62 is engaged on the inner circumferential surface of the tapered shank 102 in the above description, the clamp claw 62 may be engaged with respect to a groove or a projection on the outer circumferential surface of the tapered shank 102. Alternatively, the clamping mechanism 60 may clamp the tool 100 with a gaseous compression force.

In the above example, a part of the draw bar 64 makes the exposed portion 70 exposed outside the holder 50. In other words, the exposed portion 70 is directly and mechanically linked to the clamping mechanism 60 and moves in the direction in which the draw bar 64 moves. Alternatively, the exposed portion 70 may be a separate portion from the draw bar 64 when its mechanical linkage to the clamping mechanism 60 is ensured. The position of the exposed portion 70 and the movement direction in which the exposed portion 70 moves may desirably be changed. In this view, a transmission member for converting a movement motion attributed to the exposed portion 70 being pushed, into a movement motion from the clamping position to the unclamping position may be provided between the exposed portion 70 and the draw bar 64. For example, the exposed portion 70 may be linked to the draw bar 64 via any linkage mechanism, and the exposed portion 70 may be positioned displaced in the diameter direction relative to the draw bar 64. Further, the exposed portion 70 may be pushed in a direction intersecting the moving direction of the draw bar 64. For example, a rack on the draw bar 64 and a pinion to be engaged with the rack may be provided as a transmission means, and a part of a handle for causing the pinion to rotate (swing) may be used as the exposed portion 70 exposed outside the holder 50. In this configuration, the exposed portion 70 is pushed in a direction intersecting the axial direction of the draw bar 64. Further, a plurality of gears (a deceleration mechanism), a hydraulic mechanism, or a boosting mechanism may be provided between the exposed portion 70 and the draw bar 64 to boost a force for pushing the exposed portion 70 to transmit the boosted force to the draw bar 64. Still further, if a moving body to therewith push the exposed portion 70 or a structure to be pressed by the exposed portion 70 partially projects so that the exposed portion 70 can be pushed/pressed, the exposed portion 70 does not necessarily project outside the holder 50.

### REFERENCE SIGNS LIST

10 machine tool, 16 tailstock, 18 tool post, 19 turret, 20 built-in robot, 22 hand mechanism, 32 workpiece main spindle, 33 chuck, 34 controller, 36 main rotation shaft 38a, 38b, 54a, 54b bevel gear, 39 primary following rotation shaft, 48 spigot hole, 50 holder, 52 secondary following rotation shaft, 56 tool rotating shaft, 60 clamping mechanism, 62 clamp claw, 64 draw bar, 66 urging member, 68 tapered surface, 70 exposed portion, 74 tool insertion hole, 100 tool, 102 tapered shank, 104 engagement groove, 110 workpiece, 120 tailstock center.

1. A holder for holding a held member that is a tool or a tailstock center, the holder comprising:
a clamping mechanism for clamping the held member, the clamping mechanism being switchable between a clamping state and an unclamping state, the clamping state being a state in which the held member is hindered from being removed from the holder, the unclamping state being a state in which the held member is allowed to be removed from the holder; and
an exposed portion exposed outside the holder and directly or indirectly and mechanically linked to the clamping mechanism, the exposed portion for being pushed in one direction for movement to thereby switch the clamping mechanism to the unclamping state.

2. The holder according to claim 1, wherein
the clamping mechanism includes
a clamping claw being movable between an engaged position and a released position, the engaged position being a position where the clamping claw is engaged with the held member, the released position being a position where engagement of the clamping claw is released,
a draw bar being movable between a clamping position and an unclamping position, the clamping position being a position where the clamping claw is hindered from being displaced from the engaged position, the unclamping position being a position where the clamping claw is allowed to be displaced from the engaged position to the released position; and
an urging member for urging the draw bar toward the clamping position.

3. The holder according to claim 2, wherein
one end of the draw bar is exposed outside the holder,
a part of the draw bar functions as the exposed portion, the part being exposed outside,
the urging member urges the draw bar in a direction in which the exposed portion moves further outside the holder, and
the exposed portion is pushed toward inside the holder against an urging force of the urging member, whereby the held member is unclamped.

4. The holder according to claim 2, wherein
the exposed portion is linked to the draw bar via a transmission mechanism, and
the transmission mechanism converts a movement motion attributed to the exposed portion being pushed into a movement motion from the clamping position to the unclamping position to transmit the converted movement motion to the draw bar.

5. The holder according to claim 2, wherein
the holder is to be mounted on a turret of a machine tool,
the holder further comprises
a tool rotating shaft disposed coaxial to the draw bar, for engagement with the held member in a circumferential direction in the clamping state, and
a transmission mechanism including one or more pairs of gears, for transmitting rotation of a main rotation shaft of the turret to the tool rotating shaft, and
the rotation of the main rotation shaft is transmitted to the held member via the transmission mechanism and the tool rotating shaft.

6. A machine tool comprising:
the holder according to claim 1; and
a moving body for pushing the exposed portion in the one direction for movement.

7. The machine tool according to claim 6, wherein
the holder is mounted on a turret mounted on a tool post, and
the moving body is any of a tailstock, a counter spindle, another tool post, and another turret mounted on the other tool post.

8. The machine tool according to claim 6, wherein
the holder is mounted on a tailstock, and
the moving body is any of a counter spindle, a turret, and a tool post.

9. A machine tool, comprising:
the holder according to claim 1; and
a moving body on which the holder is to be mounted,
wherein
the moving body is moved to thereby press the exposed portion onto a structure other than the moving body whereby the held member is unclamped.

10. The machine tool according to claim 6, further comprising an exchange mechanism for removing or inserting the held member with respect to the holder in the unclamping state.
